(19) United States
(12) Patent Application Publication
(10) Pub. No.: US 2026/0206981 A1
(43) Pub. Date: Jul. 23, 2026

(54) SELF-LEARNING SLEEP OPTIMIZATION SYSTEM FOR AI-DRIVEN MATTRESSES

(71) Applicant: iFutureLab Inc, Palo Alto, CA (US)

(72) Inventors: Jack Brown, Palo Alto, CA (US); David Harris, Palo Alto, CA (US)

(21) Appl. No.: 19/026,972

(22) Filed: Jan. 17, 2025

(51) Int. Cl. A47C 31/00; A47C 20/04; A47C 21/04; A47C 27/08; A47C 27/10; G05B 13/02

(52) U.S. Cl. CPC A47C 31/00; A47C 20/048; A47C 21/042; A47C 27/082; A47C 27/083; A47C 27/10; G05B 13/027

(57) ABSTRACT

The present disclosure relates to a self-learning sleep optimization system for AI-driven mattresses. The system includes a multi-sensor data acquisition module 1 that collects user data such as pressure, temperature, humidity, heart rate, and breathing rate via sensors distributed across the mattress. An artificial intelligence algorithm module, incorporating deep learning and reinforcement learning, processes this data to generate personalized adjustment strategies. These strategies are executed by a multifunctional adjustment device, which adjusts the mattress's height, softness, and temperature using electric airbags, an air pump, control valves, and temperature control devices. A self-learning database and remote communication module stores long-term sleep data and synchronizes with a cloud database for multi-device management.

### TECHNICAL FIELD

The present disclosure relates to the technical field of intelligent sleep systems, and in particular to a self-learning sleep optimization system for AI-driven mattresses that automatically adjusts parameters such as height, hardness, and temperature through intelligent algorithms and long-term data analysis for personalized sleep optimization.

### BACKGROUND

Intelligent mattresses have seen significant advancements, particularly in the development of systems aimed at optimizing sleep through various adjustable parameters. The primary challenge in this domain is the inability of existing smart mattress systems to dynamically adapt to individual users'sleep patterns over time. Traditional systems often rely on pre-set adjustment modes that do not account for the evolving nature of a user's sleep habits and physiological changes, thereby limiting the effectiveness of personalized sleep optimization.

Current state-of-the-art solutions in smart mattress technology predominantly utilize software-based algorithms for data analysis and adjustment strategy formulation. These systems, however, face significant limitations in computational efficiency, often resulting in delays during complex data processing tasks. This inefficiency hinders the ability to perform real-time and precise adjustments, which are crucial for effective sleep optimization. Furthermore, the high-power consumption associated with these traditional methods makes them unsuitable for continuous, long-term operation.

The limitations of existing solutions are further compounded by the lack of integration of advanced AI technologies, such as hardware accelerators, which have shown promise in other fields for enhancing computational speed and energy efficiency. Despite the potential benefits, the application of such technologies in smart mattress systems remains underdeveloped. This gap highlights the need for a more efficient approach to adaptive sleep monitoring and adjustment, one that can leverage the capabilities of AI-driven hardware to overcome the current drawbacks.

In light of these deficiencies, there is a pressing need for a self-learning sleep optimization system for AI-driven mattresses. This system would address the limitations of existing technologies by providing a more responsive and energy-efficient solution, capable of real-time adaptation to the user's sleep needs.

### SUMMARY

The present disclosure is described in the following sections by various embodiments. However, it should be understood that the disclosure can be implemented in various forms and is not limited to the specific embodiment provided herein.

Embodiments of the present disclosure provide a self-learning sleep optimization system for an artificial intelligence mattress, which comprises a multi-sensor data acquisition module configured to collect user physiological data, including pressure, temperature, humidity, heart rate, and breathing rate. This module includes pressure sensors, temperature sensors, humidity sensors, and physiological signal sensors, which are strategically distributed across different areas of the mattress to ensure comprehensive data collection. The system further comprises an artificial intelligence algorithm module connected to the multi-sensor data acquisition module, employing deep learning models and reinforcement learning algorithms to analyse the collected data and generate optimized adjustment strategies. This module adapts to the user's physiological characteristics and sleeping habits, ensuring personalized sleep optimization.

The advantages of the first claim lie in its ability to provide a comprehensive and adaptive sleep optimization solution. By integrating multi-sensor data acquisition with advanced artificial intelligence algorithms, the system can continuously learn and adapt to the user's sleep patterns and physiological changes. This results in a highly personalized sleep environment that enhances comfort and sleep quality, addressing individual needs and preferences.

In accordance with an embodiment of the present disclosure, the multi-sensor data acquisition module comprises pressure, temperature, and physiological signal sensors, which are arrayed across different areas of the mattress. This configuration allows for precise monitoring of the user's physiological state and environmental conditions, facilitating accurate data collection for analysis.

In another embodiment, the artificial intelligence algorithm module comprises a deep neural network and a reinforcement learning algorithm, which work in tandem to analyse the user's sleep data and automatically adjust the adjustment strategy. The module further comprises an LSTM network for analysing long-term sleep patterns, enabling the system to predict and adapt to future sleep needs.

In accordance with an embodiment of the present disclosure, the multifunctional adjustment device comprises electric airbags, an air pump, control valves, and temperature control devices. Each adjustment unit operates independently, allowing for regional mattress adjustment based on the generated strategies. This ensures that the mattress can provide targeted support and comfort to different areas of the user's body.

Additionally, the self-learning database and remote communication module are capable of cloud synchronization, allowing for data interaction and management among multiple devices. This feature enables users to access their sleep data and adjustment records remotely, facilitating continuous improvement of the system's performance.

In another embodiment, the system comprises a user interface module for displaying sleep data, adjustment status, and providing optimization suggestions. This interface allows users to interact with the system, offering insights into their sleep patterns and enabling manual adjustments if desired.

Furthermore, the multi-sensor data acquisition module has adjustable sensitivity to accommodate different user weights and body shapes, ensuring accurate physiological data collection. This adaptability enhances the system's ability to provide personalized sleep optimization for a wide range of users.

Embodiments of the present disclosure also encompass a method for optimizing sleep on a mattress, which involves collecting user physiological data via the multi-sensor data acquisition module, analysing the collected data with the artificial intelligence algorithm module to generate an adjustment strategy, adjusting mattress parameters with the multifunctional adjustment device based on the strategy, and storing the collected data while synchronizing with external devices using the self-learning database and remote communication module. This method ensures a comprehensive approach to sleep optimization, leveraging advanced data analysis and real-time adjustments to enhance user comfort and sleep quality.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element.

In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a schematic diagram of the overall structure of the hardware accelerator, in accordance with an embodiment of the present disclosure;

FIG. 2 illustrates a schematic diagram of the structure of the multi-sensor data acquisition module, showing the distribution and connection method of sensors inside the mattress in accordance with an embodiment of the present disclosure;

FIG. 3 illustrates a functional diagram of the artificial intelligence algorithm module, showing the learning and adjustment logic of the algorithm in accordance with an embodiment of the present disclosure;

FIG. 4 illustrates a feature extraction function of the artificial intelligence algorithm module in accordance with an embodiment of the present disclosure;

FIG. 5 illustrates a pattern recognition function of the artificial intelligence algorithm module in accordance with an embodiment of the present disclosure;

FIG. 6 illustrates an adaptive learning and strategy update function of the artificial intelligence algorithm module in accordance with an embodiment of the present disclosure;

FIG. 7 illustrates a multifunctional adjustment device, showing the adjustment structure and adjustment method of the mattress in accordance with an embodiment of the present disclosure.

It should be noted that the accompanying figure is intended to present illustrations of a few examples of the present disclosure. The figure is not intended to limit the scope of the present disclosure. It should also be noted that the accompanying figure is not necessarily drawn to scale.

### DETAILED DESCRIPTION OF THE EMBODIMENTS

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

The present disclosure relates to a self-learning sleep optimization system designed for AI-driven mattresses, which aims to enhance sleep quality by adapting to the user's physiological characteristics and sleeping habits. The system comprises a multi-sensor data acquisition module, an artificial intelligence algorithm module, a multifunctional adjustment device, and a self-learning database with a remote communication module. The multi-sensor data acquisition module is equipped with pressure, temperature, humidity, and physiological signal sensors, which are strategically distributed across the mattress to collect real-time data on the user's sleep conditions. This data is then processed and analysed by the artificial intelligence algorithm module, which employs deep learning and reinforcement learning techniques to generate personalized adjustment strategies.

The artificial intelligence algorithm module is a key component of the system, utilizing advanced deep learning models such as convolutional neural networks (CNNs) and long short-term memory (LSTM) networks to extract spatial and temporal features from the collected data. This module is designed to adaptively optimize mattress adjustment strategies, ensuring that the mattress responds to the user's long-term physiological changes and sleep patterns. The multifunctional adjustment device, which comprises electric airbags, an air pump, control valves, and temperature control devices, implements these strategies by independently adjusting the mattress's height, softness, and temperature in different regions. This allows for a tailored sleep environment that can accommodate the user's specific needs and preferences.

The self-learning database and remote communication module play a crucial role in the system's continuous improvement and adaptability. By storing long-term sleep data and adjustment records, the database enables the system to learn from past interactions and refine its strategies over time. The remote communication module facilitates synchronization with a cloud database, allowing for data interaction and management across multiple devices. This feature ensures that the system remains up-to-date with the latest user feedback and environmental changes, thereby maintaining optimal performance. Additionally, a user interface module may be included to provide users with insights into their sleep data and adjustment status, as well as to offer optimization suggestions based on the system's analysis.

The current disclosure pertains to an autonomous learning system that optimizes sleep for AI-enhanced mattresses, which comprises a built-in hardware accelerator that boosts real-time processing, evaluation, and enhancement of sleep data. This hardware accelerator consists of four fundamental components: a data input module, a deep learning acceleration module, a strategy generation acceleration module, and a multifunctional adjustment device, all of which work together to enhance the system's effectiveness and responsiveness.

The data input module gathers multi-sensor information, such as pressure, temperature, humidity, heart rate, and breathing rate, via a network of carefully positioned sensors. These sensors collect real-time data regarding the user's sleeping conditions and physiological status. The module converts analog inputs into digital formats using an analog-to-digital converter (ADC) and executes signal normalization to guarantee compatibility with later data processing stages. Included among the sensors are temperature sensors, humidity sensors, pressure sensors, and vital sign sensors (monitoring heart rate and breathing rate). These sensors are distributed across the mattress to oversee environmental factors and observe pressure changes critical for adjustable mattress settings.

The deep learning acceleration module employs FPGA (Field-Programmable Gate Array) or ASIC (Application-Specific Integrated Circuit) frameworks to expedite the calculations required for deep learning models such as Convolutional Neural Networks (CNNs) and Long Short-Term Memory (LSTM) networks. This module extracts and scrutinizes features from the sensor data, enabling the identification of sleep patterns, pressure distributions, and variations in the environment in real time. It also improves anomaly detection capabilities, identifying immediate issues such as snoring, excessive movement, or fluctuations in temperature, which facilitates short-term mattress adjustments.

The strategy generation acceleration module applies advanced reinforcement learning techniques, including Deep Q-Networks (DQN) and policy gradient methods, in hardware to expedite the formulation of mattress adjustment strategies. This module generates tailored parameters for mattress features like firmness, height, and temperature in accordance with the user's physiological requirements. By processing real-time responses and long-term sleep data, the system guarantees that mattress adjustments are both responsive and adaptable to changing sleep patterns.

The multifunctional adjustment device features electric airbags, airbag control valves, a master control valve, and an air pump. These components dynamically adjust the height, firmness, and support of the mattress by inflating or deflating airbags based on user movements and pressure changes. Other aspects include quiet air pumps and precisely controlled valves, ensuring smooth adjustments without disturbing the sleeper.

Moreover, the disclosure incorporates an artificial intelligence algorithm module that processes multi-sensor information through critical phases: data acquisition, preprocessing, feature extraction, pattern recognition, and adaptive learning. The system utilizes Convolutional Neural Networks (CNNs) and Long Short-Term Memory (LSTM) networks to detect both short-term irregularities such as posture instability and temperature variations, as well as long-term trends, including deep sleep cycles and changes in spinal alignment. The adaptive learning mechanism consistently fine-tunes adjustment strategies based on user feedback and updated neural network configurations. Real-time monitoring and predictive analysis enable the system to foresee user requirements and implement proactive adjustments.

Additionally, the system features a user interface module, which allows users to track sleep quality, access real-time sensor data, and receive personalized insights regarding their sleep behaviours. This interface may also offer suggestions for enhancing sleep comfort based on the system's evaluations. Cloud-based synchronization ensures smooth data management across various devices, supporting ongoing learning and refinement.

The multifunctional adjustment device encompasses robust airbags situated throughout the mattress, regulated by precise air valves and a centralized control system. The air pump guarantees quick adjustments while also ensuring quiet operation. In certain instances, the adjustment device might include electric airbags, an air pump, control valves, or temperature management features to further boost adaptability. These components collaboratively contribute to delivering personalized support, ensuring spinal alignment, pressure alleviation, and thermal comfort.

In one aspect, the feature extraction function detects variations in pressure distribution, humidity, and temperature to identify immediate optimization requirements, such as snoring or changes in position. Over longer periods, the system examines deep sleep patterns, weight distribution, and long-term alignment trends to enhance adjustment strategies. This dual attention to both short-term irregularities and long-term patterns enables the system to provide customized solutions that evolve with the user's changing physiological needs.

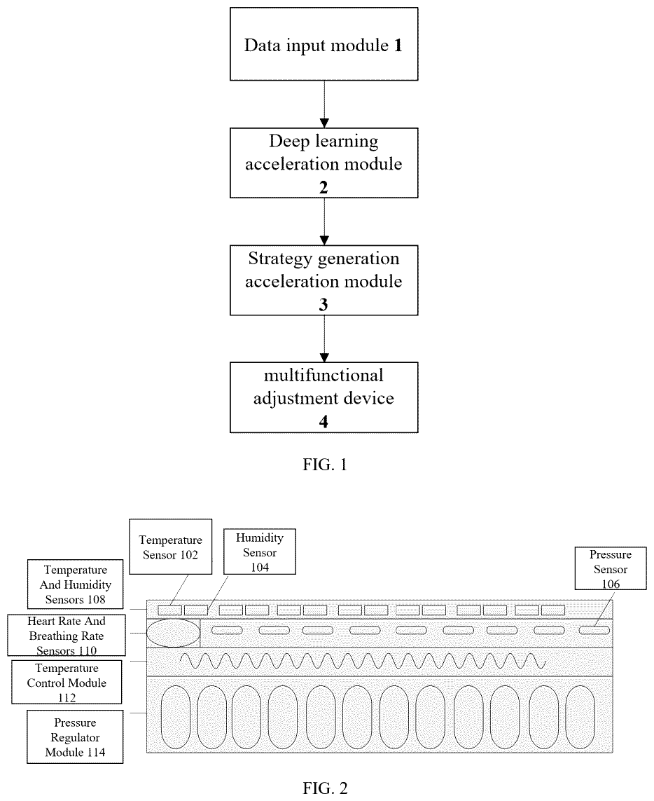

FIG. 1 illustrates a schematic diagram of the overall structure of the hardware accelerator, which is integral to the self-learning sleep optimization system for AI-driven mattresses. The hardware accelerator comprises a data input module 1, a deep learning acceleration module 2, a strategy generation acceleration module 3, and a multifunctional adjustment device 4. Each module is designed to perform specific functions that collectively enhance the efficiency and responsiveness of the sleep monitoring system.

The data input module 1 is configured to receive multi-sensor data, including pressure, temperature, humidity, heart rate, and breathing rate. This module converts the analog signals from the sensors into digital signals using an analog-to-digital converter, followed by signal normalization to ensure compatibility with subsequent processing stages. The deep learning acceleration module 2 utilizes FPGA (Field-Programmable Gate Array) or ASIC (Application-Specific Integrated Circuit) architecture to accelerate the computation of deep learning models such as Convolutional Neural Networks (CNNs) and Long Short-Term Memory (LSTM) networks, enabling rapid feature extraction and pattern recognition from the sensor data.

The strategy generation acceleration module 3 implements reinforcement learning algorithms in hardware to expedite the creation of mattress adjustment strategies. This module is responsible for optimizing parameters such as mattress height, softness, hardness, and temperature, ensuring that adjustments are responsive to the user's physiological state. The multifunctional adjustment device 4 transmits these optimized instructions to the mattress adjustment devices, utilizing an optimized communication interface to minimize latency and enhance response speed.

In one embodiment of the disclosure, the data input module 1 may include an analog-to-digital converter and a signal normalization circuit to enhance the accuracy of sensor data processing. The deep learning acceleration module 2 may employ FPGA (Field-Programmable Gate Array) or ASIC (Application-Specific Integrated Circuit) architecture to achieve parallel computing and high-throughput data processing, facilitating real-time analysis of physiological data.

Additionally, the strategy generation acceleration module 3 may utilize a Deep Q-Networks (DQN) or policy gradient algorithm implemented in hardware to optimize the generation of mattress adjustment strategies. The multifunctional adjustment device 4 may feature an optimized communication interface for low-latency transmission of adjustment instructions, improving the response speed of the mattress adjustment devices.

FIG. 2 illustrates a schematic diagram of the multi-sensor data acquisition module, detailing the distribution and connection method of sensors within the mattress. The module comprises various sensors, including temperature sensors 102, humidity sensors 104, and pressure sensors 106, strategically arrayed across the mattress to capture comprehensive physiological data. These sensors are connected to the data input module 1, which processes the collected data for further analysis.

The temperature sensors 102 and humidity sensors 104 are positioned to monitor the user's body temperature and ambient humidity levels, providing critical data for optimizing sleep conditions. The pressure sensors 106 are distributed to detect pressure distribution across the mattress, enabling the system to adjust support and comfort levels dynamically. The integration of these sensors ensures a holistic understanding of the user's sleep environment.

In one embodiment of the disclosure, the temperature and humidity sensors 108 work in conjunction with the heart rate and breathing rate sensors 110 to provide real-time monitoring of the user's physiological state. The temperature control module 112 and pressure regulator module 114 are responsible for maintaining optimal conditions by adjusting the mattress's temperature and pressure based on the data received from the sensors.

Additionally, the system may include a temperature control module 112 that utilizes the data from the temperature sensors 102 to regulate the mattress's heating or cooling elements, ensuring a consistent and comfortable sleep temperature. The pressure regulator module 114 adjusts the mattress's firmness by modulating the pressure in the air chambers, responding to the data from the pressure sensors 106.

In another embodiment, the heart rate and breathing rate sensors 110 provide vital signs data, which is crucial for detecting sleep stages and potential disturbances such as apnea. This data is processed by the artificial intelligence algorithm module to generate personalized adjustment strategies, enhancing the user's sleep quality by adapting to their physiological needs.

The system further comprises a self-learning database that stores the collected data and adjustment records, allowing for continuous improvement of the adjustment strategies. The remote communication module facilitates synchronization with external devices, enabling users to access their sleep data and receive optimization suggestions through a user interface. This integration of multi-sensor data acquisition and intelligent adjustment mechanisms exemplifies the disclosure's capability to provide a personalized and adaptive sleep environment.

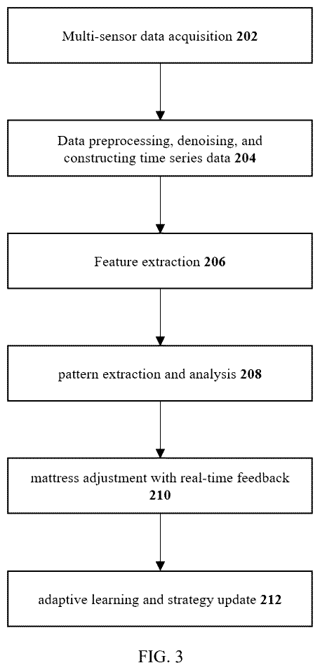

FIG. 3 illustrates a functional diagram of the artificial intelligence algorithm module, detailing the learning and adjustment logic of the algorithm. The module begins with multi-sensor data acquisition 202 using the data input module 1, which collects physiological data such as pressure, temperature, humidity, heart rate, and breathing rate. This data undergoes preprocessing, denoising, and time series construction 204 to prepare it for further analysis.

Feature extraction 206 is performed using the deep learning acceleration module 2, which employs FPGA (Field-Programmable Gate Array) or ASIC (Application-Specific Integrated Circuit) architecture to expedite the processing of deep learning models like Convolutional Neural Networks (CNNs) and Long Short-Term Memory (LSTM) networks. This step is crucial for identifying relevant patterns and features from the raw sensor data. Pattern extraction and analysis 208 follow, utilizing the same acceleration module to recognize sleep patterns and anomalies, which are essential for generating effective adjustment strategies.

Mattress adjustment with real-time feedback 210 is executed by the multifunctional adjustment device module 4, which applies the optimized strategies to the multifunctional adjustment device. This ensures that the mattress parameters are continuously adapted to the user's physiological state, providing immediate comfort and support adjustments. Adaptive learning and strategy update 212 are facilitated by the strategy generation acceleration module 3, which refines the adjustment strategies based on ongoing data analysis and user feedback.

In one embodiment of the disclosure, the data preprocessing stage 204 may include advanced denoising techniques to enhance the accuracy of the data fed into the deep learning models. The feature extraction process 206 may leverage parallel computing capabilities of FPGA (Field-Programmable Gate Array) or ASIC (Application-Specific Integrated Circuit) to handle large volumes of data efficiently, ensuring timely pattern recognition.

Additionally, the pattern extraction and analysis 208 may incorporate a combination of deep neural networks and reinforcement learning algorithms to identify complex sleep patterns and anomalies. The real-time feedback mechanism 210 ensures that any detected changes in the user's physiological state are promptly addressed by adjusting the mattress parameters.

In another embodiment, the adaptive learning and strategy update 212 may utilize Long Short-Term Memory (LSTM) networks to analyse long-term sleep patterns and predict future needs, allowing the system to pre-emptively adjust the mattress settings. This continuous learning capability ensures that the system remains responsive to the user's evolving sleep requirements.

The system's ability to integrate multi-sensor data acquisition with advanced AI-driven analysis and real-time adjustment exemplifies its potential to provide a highly personalized and adaptive sleep environment. The self-learning database and remote communication module further enhance this capability by storing historical data and facilitating interaction with external devices, enabling users to monitor their sleep quality and receive tailored optimization suggestions.

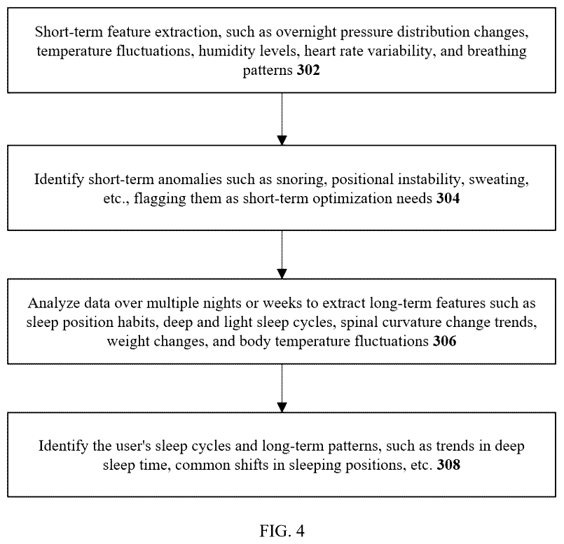

FIG. 4 illustrates a feature extraction function of the artificial intelligence algorithm module, highlighting the steps involved in processing and analysing sleep data. The deep learning acceleration module 2 is employed to perform short-term feature extraction (Step 302), capturing overnight changes in pressure distribution, temperature fluctuations, humidity levels, heart rate variability, and breathing patterns. This step is essential for identifying immediate adjustments needed to enhance sleep quality.

Short-term anomalies such as snoring, positional instability, and sweating are identified (Step 304) and flagged as optimization needs. The system's ability to detect these anomalies allows for timely interventions, ensuring that the mattress adjusts to provide optimal support and comfort. The deep learning acceleration module 2 processes this data efficiently, leveraging its high-throughput capabilities.

In one embodiment of the disclosure, the system analyses data over multiple nights or weeks (Step 306) to extract long-term features such as sleep position habits, deep and light sleep cycles, spinal curvature change trends, weight changes, and body temperature fluctuations. This comprehensive analysis enables the system to understand the user's sleep patterns and adapt the mattress settings accordingly.

The identification of the user's sleep cycles and long-term patterns (Step 308) is crucial for generating predictive adjustment strategies. By recognizing trends in deep sleep time and common shifts in sleeping positions, the system can pre-emptively adjust the mattress to accommodate these patterns, enhancing overall sleep quality.

Additionally, the system may employ advanced machine learning techniques to refine the feature extraction process, ensuring that both short-term and long-term data are accurately captured and analysed. This capability allows the system to continuously learn and adapt to the user's evolving sleep needs, providing a personalized and responsive sleep environment.

In another embodiment, the system's ability to integrate real-time data with historical trends enables it to offer tailored optimization suggestions through a user interface. This feature empowers users to make informed decisions about their sleep environment, further enhancing the system's effectiveness in improving sleep quality.

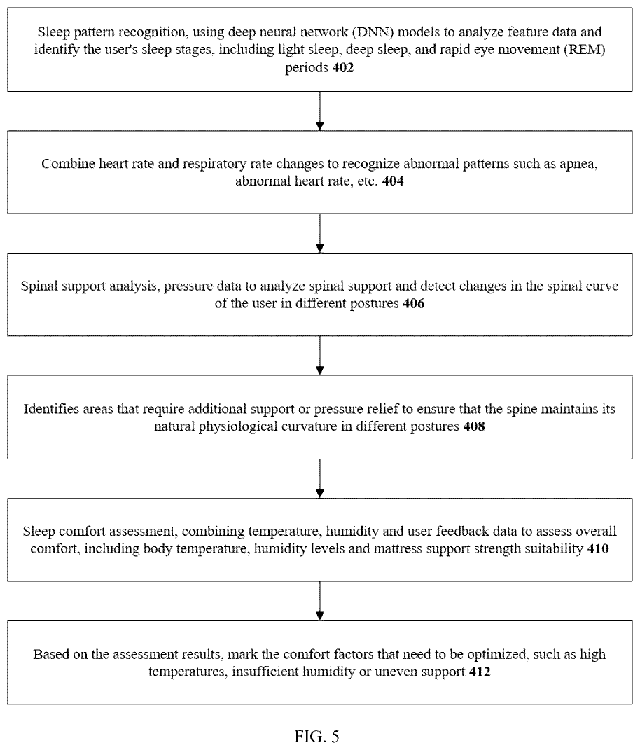

FIG. 5 illustrates a pattern recognition function of the artificial intelligence algorithm module, which utilizes the deep learning acceleration module 2 to analyse sleep data and identify various sleep stages and patterns. The process begins with sleep pattern recognition (Step 402), where deep neural network (DNN) models are employed to analyse feature data and identify the user's sleep stages, including light sleep, deep sleep, and rapid eye movement (REM) periods. This analysis is crucial for understanding the user's sleep architecture and tailoring mattress adjustments accordingly.

The module combines heart rate and respiratory rate changes (Step 404) to recognize abnormal patterns such as apnea and abnormal heart rate. This capability allows the system to detect potential sleep disturbances and adjust the mattress settings to mitigate their impact, thereby enhancing sleep quality. The integration of physiological data ensures a comprehensive assessment of the user's sleep state.

Spinal support analysis (Step 406) involves using pressure data to evaluate spinal support and detect changes in the spinal curve of the user in different postures. This analysis helps identify areas that require additional support or pressure relief (Step 408) to maintain the spine's natural physiological curvature. By ensuring proper spinal alignment, the system contributes to the user's overall comfort and health.

In one embodiment of the disclosure, the sleep comfort assessment (Step 410) combines temperature, humidity, and user feedback data to evaluate overall comfort, including body temperature, humidity levels, and mattress support strength suitability. This assessment identifies comfort factors that need optimization, such as high temperatures, insufficient humidity, or uneven support (Step 412). The system's ability to assess and adjust these factors ensures a personalized and comfortable sleep environment.

Additionally, the system may incorporate user feedback mechanisms to refine the comfort assessment process, allowing for continuous improvement of the adjustment strategies. This feedback loop enables the system to adapt to the user's preferences and evolving needs, providing a tailored sleep experience.

In another embodiment, the system's pattern recognition capabilities extend to identifying long-term trends in sleep quality and comfort, enabling predictive adjustments that anticipate the user's needs. This proactive approach ensures that the mattress settings are always optimized for the user's current and future sleep requirements, enhancing the overall effectiveness of the sleep optimization system.

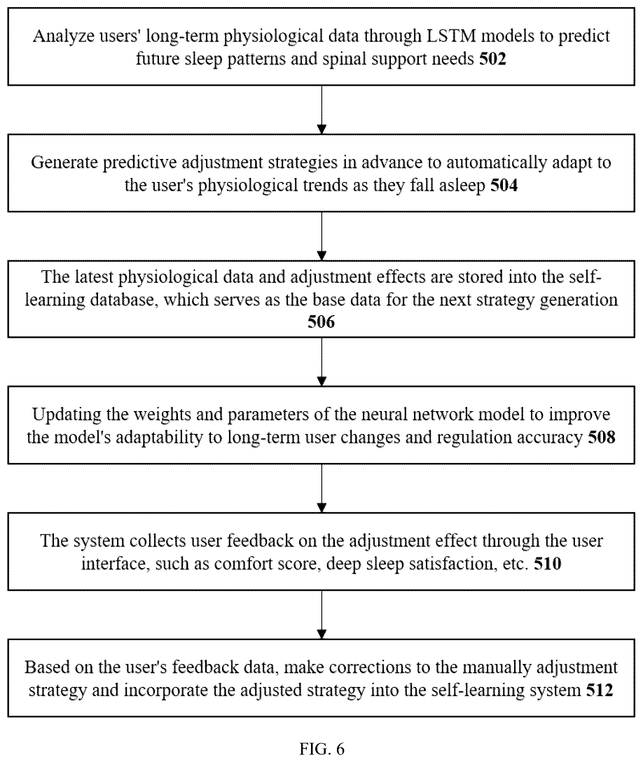

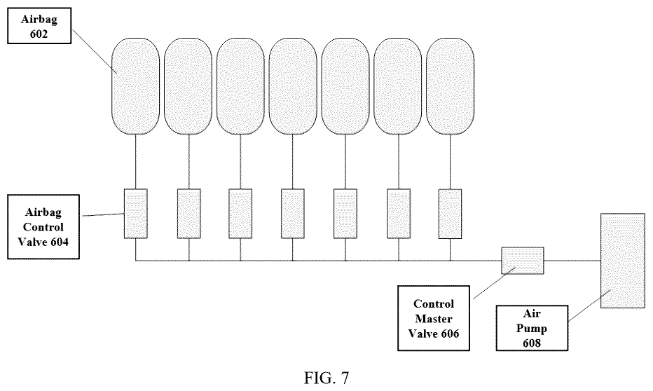

FIG. 6 illustrates an adaptive learning and strategy update function of the artificial intelligence algorithm module. This function is integral to the system's ability to continuously refine and optimize mattress adjustment strategies based on user data. The process begins with analysing users'long-term physiological data through LSTM models (Step 502) to predict future sleep patterns and spinal support needs. This predictive capability allows the system to anticipate changes in the user's sleep requirements and adjust the mattress settings accordingly.

The generation of predictive adjustment strategies (Step 504) is performed in advance to automatically adapt to the user's physiological trends as they fall asleep. This proactive approach ensures that the mattress provides optimal support and comfort throughout the night, enhancing the user's sleep quality. The strategy generation acceleration module 3 plays a crucial role in expediting this process, leveraging hardware-implemented reinforcement learning algorithms to generate effective strategies swiftly.

The latest physiological data and adjustment effects are stored in the self-learning database (Step 506), serving as the base data for the next strategy generation. This continuous data collection and storage enable the system to learn from past adjustments and refine future strategies, ensuring that the mattress settings remain aligned with the user's evolving needs. The remote communication module facilitates synchronization with external devices, allowing users to access their sleep data and receive optimization suggestions.

Updating the weights and parameters of the neural network model (Step 508) improves the model's adaptability to long-term user changes and regulation accuracy. This ongoing refinement of the model ensures that the system remains responsive to the user's physiological state, providing personalized and adaptive sleep solutions. The strategy generation acceleration module 3 is instrumental in this process, utilizing advanced machine learning techniques to enhance the model's performance.

The system collects user feedback on the adjustment effect through the user interface (Step 510), such as comfort score and deep sleep satisfaction. This feedback is crucial for assessing the effectiveness of the adjustment strategies and identifying areas for improvement. Based on the user's feedback data, corrections are made to the manually adjusted strategy (Step 512), and the adjusted strategy is incorporated into the self-learning system. This feedback loop ensures that the system continuously evolves to meet the user's preferences and needs, providing a tailored sleep experience.

In one embodiment of the disclosure, the user interface may offer detailed sleep reports and optimization suggestions, empowering users to make informed decisions about their sleep environment. The integration of user feedback into the strategy update process ensures that the system remains aligned with the user's expectations and delivers a personalized sleep solution.

Additionally, the system's ability to predict and adapt to long-term trends in sleep patterns and physiological needs exemplifies its potential to provide a highly responsive and adaptive sleep environment. The combination of advanced AI-driven analysis, real-time adjustment, and continuous learning ensures that the system delivers optimal sleep quality and comfort for the user.

FIG. 7 illustrates a multifunctional adjustment device, detailing the adjustment structure and method of the mattress. The device comprises airbags 602, airbag control valves 604, a control master valve 606, and an air pump 608. These components work in unison to adjust the mattress's firmness and support in response to the user's physiological data.

The airbags 602 are strategically positioned within the mattress to provide adjustable support and comfort. Each airbag is connected to an airbag control valve 604, which regulates the air pressure within the airbag, allowing for precise control over the mattress's firmness. The control master valve 606 coordinates the operation of multiple airbag control valves, ensuring synchronized adjustments across different mattress regions.

The air pump 608 supplies the necessary air pressure to the airbags, enabling rapid inflation or deflation as required. This setup allows the system to dynamically adjust the mattress's support and comfort levels based on real-time data from the multi-sensor data acquisition module. The materials used for the airbags and valves are selected for durability and flexibility, ensuring long-term reliability and performance.

In one embodiment of the disclosure, the multifunctional adjustment device 4 interfaces with the airbag control valves 604 to execute the optimized adjustment strategies generated by the artificial intelligence algorithm module. This integration ensures that the mattress responds promptly to changes in the user's physiological state, providing immediate comfort and support adjustments.

Additionally, the system may include a silent design feature, utilizing sound insulation materials and low-noise motors to minimize noise and vibration during the adjustment process. This ensures that the user's sleep is not disturbed by the operation of the adjustment device, enhancing overall sleep quality.

In another embodiment, the air pump 608 may be equipped with a variable speed motor, allowing for precise control over the inflation and deflation rates of the airbags. This capability enables the system to fine-tune the mattress's support and comfort levels, accommodating the user's specific needs and preferences.

The multifunctional adjustment device exemplifies the disclosure's ability to provide a personalized and adaptive sleep environment. By integrating advanced control mechanisms with real-time data analysis, the system ensures that the mattress settings are continuously optimized for the user's comfort and support, enhancing overall sleep quality.

The method for optimizing sleep on a mattress, as implemented in the present disclosure, involves a systematic approach to collecting, analysing, and responding to user physiological data. The multi-sensor data acquisition module 1 captures real-time data, which is then processed by the artificial intelligence algorithm module to generate an adjustment strategy. This strategy is executed by the multifunctional adjustment device, which adjusts mattress parameters such as height, softness, and temperature in response to the user's physiological state. The self-learning database and remote communication module store the collected data and facilitate synchronization with external devices, ensuring continuous improvement of the adjustment strategies.

In an embodiment of the present disclosure, the system may incorporate additional sensors or alternative data processing techniques to enhance the accuracy and responsiveness of the sleep optimization process. For instance, the integration of advanced biometric sensors could provide more detailed insights into the user's physiological state, allowing for even more precise adjustments. Furthermore, the system may be adapted to accommodate different mattress types or configurations, providing flexibility in its application across various sleep environments.

The disclosure's benefits are underscored by its ability to provide a highly personalized and adaptive sleep environment. The integration of multi-sensor data acquisition, advanced AI-driven analysis, and real-time adjustment mechanisms ensures that the system continuously adapts to the user's evolving sleep needs. The technical features, such as the deep learning acceleration module and strategy generation acceleration module, enable rapid processing and implementation of adjustment strategies, enhancing the system's overall efficiency and effectiveness. By leveraging these capabilities, the disclosure significantly improves sleep quality, offering users a tailored and responsive sleep solution that adapts to their unique physiological characteristics and sleeping habits.

Although, the present disclosure has been described with reference to certain preferred embodiments and examples thereof, other embodiments and equivalents are possible. Even though numerous characteristics and advantages of the present disclosure have been set forth in the foregoing description, together with functional and procedural details, the disclosure is illustrative only, and changes may be made in detail, within the principles of the disclosure to the full extent indicated by the broad general meaning of the terms. Thus, various modifications are possible of the presently disclosed system and process without deviating from the intended scope and spirit of the present disclosure.

What is claimed is:

1. A self-learning sleep optimization system for AI-driven mattresses, comprising:
a multi-sensor data acquisition module configured to collect real-time physiological data of a user during sleep, comprising pressure, temperature, humidity, heart rate, and breathing rate, wherein the module comprises a plurality of sensors distributed across different areas of the mattress;
an artificial intelligence algorithm module connected to the multi-sensor data acquisition module, comprising deep learning models and reinforcement learning algorithms, configured to analyse the collected data and generate optimized adjustment strategies based on the user's physiological characteristics and sleeping habits;
a multifunctional adjustment device comprising electric airbags, an air pump, control valves, and temperature control devices, configured to execute the optimized adjustment instructions and facilitate real-time regional adjustment of the mattress, independently adjust the height, softness, and temperature of the mattress in different areas according to the optimized adjustment strategies;
a self-learning database and remote communication module configured to store the user's long-term sleep data and adjustment records, and to synchronize with a cloud database for data interaction and management across multiple devices; and
wherein the artificial intelligence algorithm module further comprises a deep learning acceleration module utilizing FPGA or ASIC architecture to expedite the operation of deep learning models, and a strategy generation acceleration module to accelerate the reinforcement learning algorithm for real-time mattress adjustment.

2. The self-learning sleep optimization system of claim 1, wherein the multi-sensor data acquisition module further comprises an analog-to-digital converter and a signal normalization to enhance the accuracy of sensor data processing.

3. The self-learning sleep optimization system of claim 1, wherein the artificial intelligence algorithm module comprises a convolutional neural network (CNN) and a long short-term memory (LSTM) network for analysing long-term sleep patterns and generating predictive adjustment strategies.

4. The self-learning sleep optimization system of claim 1, wherein the multifunctional adjustment device comprises a silent operation feature, incorporating multiple layers of sound insulation materials and a low-noise motor to reduce noise and vibration during the adjustment process.

5. The self-learning sleep optimization system of claim 1, further comprising a user interface module configured to display sleep data, adjustment status, and provide optimization suggestions, allowing users to manually set adjustment parameters.

6. The self-learning sleep optimization system of claim 1, wherein the remote communication module supports synchronization with a cloud database, facilitating data interaction and management among multiple devices.

7. The self-learning sleep optimization system of claim 1, wherein the multifunctional adjustment device utilize an optimized communication interface to minimize latency and enhance response speed during mattress adjustment.

8. A method for optimizing sleep on a mattress using the self-learning sleep optimization system of claim 1, comprising:
collecting user physiological data via the multi-sensor data acquisition module;
analysing the collected data with the artificial intelligence algorithm module to generate an adjustment strategy;
adjusting mattress parameters with the multifunctional adjustment device based on the strategy; and
storing the collected data and synchronizing with external devices using the self-learning database and remote communication module.

9. The method of claim 8, wherein the multi-sensor data acquisition module comprises pressure, temperature, and physiological signal sensors.

10. The method of claim 9, wherein the sensors are distributed in an array across different areas of the mattress.

11. The method of claim 8, wherein the artificial intelligence algorithm module utilizes a deep neural network and a reinforcement learning algorithm.

12. The method of claim 11, wherein the artificial intelligence algorithm module further employs an LSTM network for long-term sleep pattern analysis.

13. The method of claim 8, wherein collecting user physiological data comprises detecting pressure, temperature, humidity, heart rate, and breathing rate.

14. The method of claim 8, wherein executing the adjustment strategy comprises independently adjusting electric airbags, an air pump, control valves, and temperature control devices in the mattress.

15. A sleep optimization system for a mattress, comprising:
a multi-sensor data acquisition module for collecting user physiological data;
an artificial intelligence algorithm module connected to the multi-sensor data acquisition module for analyzing the collected data and generating an adjustment strategy;
a multifunctional adjustment device for adjusting mattress parameters based on the strategy; and
a self-learning database and remote communication module for storing data and synchronizing with external devices.

16. The system of claim 15, wherein the multi-sensor data acquisition module comprises pressure, temperature, and physiological signal sensors.

17. The system of claim 16, wherein the sensors are arrayed across different areas of the mattress.

18. The system of claim 15, wherein the artificial intelligence algorithm module comprises a deep neural network and a reinforcement learning algorithm.

19. The system of claim 18, wherein the artificial intelligence algorithm module further comprises an LSTM network for analyzing long-term sleep patterns.

20. The system of claim 15, wherein the multifunctional adjustment device comprises electric airbags, an air pump, control valves, and temperature control devices.
